(19) United States
(12) Patent Application Publication
(10) Pub. No.: US 2025/0128394 A1
(43) Pub. Date: Apr. 24, 2025

(54) POWER TOOL AND REMOVABLE USER INTERFACE GUARD

(71) Applicant: Ingersoll-Rand Industrial U.S., Inc., Davidson, NC (US)

(72) Inventors: Joshua O. Johnson, Allentown, PA (US); James F. Bouchard, Easton, PA (US); Roger B. Davis, Andover, NJ (US)

(21) Appl. No.: 18/909,275

(22) Filed: Oct. 8, 2024

Related U.S. Application Data
(60) Provisional application No. 63/589,106, filed on Oct. 10, 2023.

(51) Int. Cl. B25F 5/02; B25B 21/02

(52) U.S. Cl. CPC B25F 5/02; B25B 21/02

(57) ABSTRACT

A power tool includes a housing having a working end and a side (e.g., back side) separate from the working end, and a user interface supported by the housing and positioned on the side of the housing. The power tool can also include one or more protrusions defined by the housing proximate to the user interface and extending away from the housing for protecting the user interface from an impact on the side of the housing. A removable user interface guard for the power tool includes a body formed of an impact resistant material for protecting the user interface of the power tool from an impact at the side of the power tool, and a retention feature on the body configured to mate with a corresponding feature on the housing of the power tool to removably secure the body to the side of the housing over the user interface.

### CROSS-REFERENCE TO RELATED APPLICATIONS

The present application claims the benefit under 35 U.S.C. § 119 (e) of U.S. Provisional Application Ser. No. 63/589,106, filed Oct. 10, 2023, and titled “POWER TOOL WITH REMOVABLE USER INTERFACE GUARD,” which is herein incorporated by reference in its entirety.

### BACKGROUND

A power tool is a tool actuated by a power source other than manual labor.

### DRAWINGS

The Detailed Description is described with reference to the accompanying figures. The use of the same reference numbers in different instances in the description and the figures may indicate similar or identical items.

FIG. 1 is an isometric view illustrating an impact tool with a user interface in accordance with example embodiments of the present disclosure.

FIG. 2 is another isometric view of the impact tool illustrated in FIG. 1.

FIG. 3 is a top plan view of the impact tool illustrated in FIG. 1.

FIG. 4 is a bottom plan view of the impact tool illustrated in FIG. 1.

FIG. 5 is a rear elevation view of the impact tool illustrated in FIG. 1.

FIG. 6 is a right side elevation view of the impact tool illustrated in FIG. 1.

FIG. 7 is a left side elevation view of the impact tool illustrated in FIG. 1.

FIG. 8 is an isometric view illustrating an impact tool with a user interface and a removable guard for the user interface in accordance with example embodiments of the present disclosure.

FIG. 9 is another isometric view of the impact tool illustrated in FIG. 8.

FIG. 10 is a top plan view of the impact tool illustrated in FIG. 8.

FIG. 11 is a bottom plan view of the impact tool illustrated in FIG. 8.

FIG. 12 is a rear elevation view of the impact tool illustrated in FIG. 8.

FIG. 13 is a right side elevation view of the impact tool illustrated in FIG. 8.

FIG. 14 is a left side elevation view of the impact tool illustrated in FIG. 8.

FIG. 15 is an isometric view illustrating a removable guard for a user interface of a power tool, such as the power tools illustrated in FIGS. 1 through 14, in accordance with example embodiments of the present disclosure.

FIG. 16 is another isometric view of the removable guard illustrated in FIG. 17.

FIG. 17 is a top plan view of the removable guard illustrated in FIG. 17.

FIG. 18 is a bottom plan view of the removable guard illustrated in FIG. 17.

FIG. 19 is a front elevation view of the removable guard illustrated in FIG. 17.

FIG. 20 is a rear elevation view of the removable guard illustrated in FIG. 17.

FIG. 21 is a right side elevation view of the removable guard illustrated in FIG. 17.

FIG. 22 is a left side elevation view of the removable guard illustrated in FIG. 17.

FIG. 23 is an isometric view illustrating another impact tool with a user interface in accordance with example embodiments of the present disclosure.

FIG. 24 is another isometric view of the impact tool illustrated in FIG. 23.

FIG. 25 is an isometric view illustrating another removable guard for a user interface of a power tool, such as the power tool illustrated in FIGS. 23 and 24, in accordance with example embodiments of the present disclosure.

FIG. 26 is another isometric view of the removable guard illustrated in FIG. 25.

FIG. 27 is a rear elevation view illustrating an impact tool with a user interface and a removable guard for the user interface in accordance with example embodiments of the present disclosure.

### DETAILED DESCRIPTION

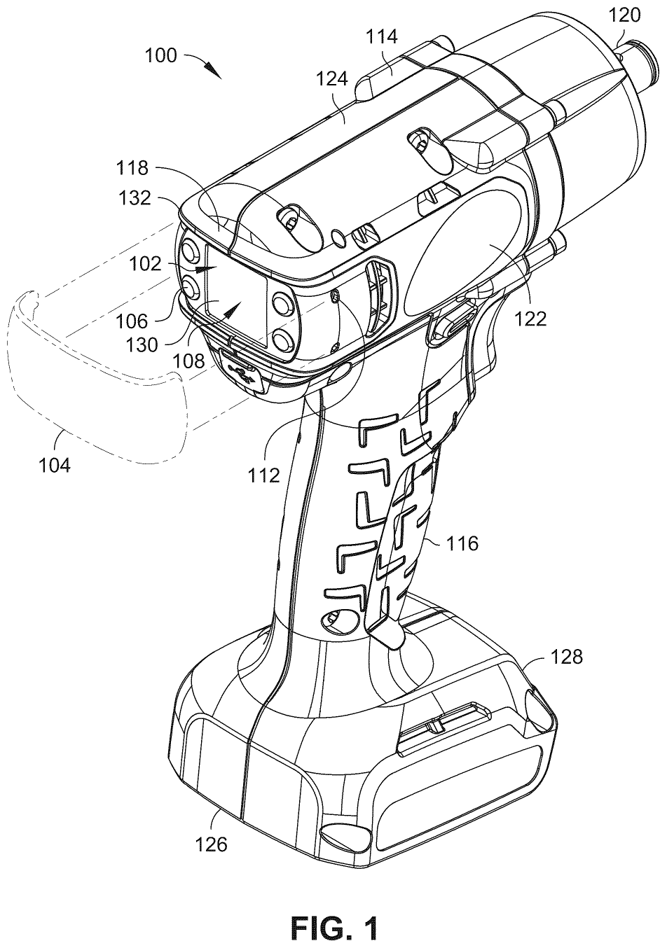

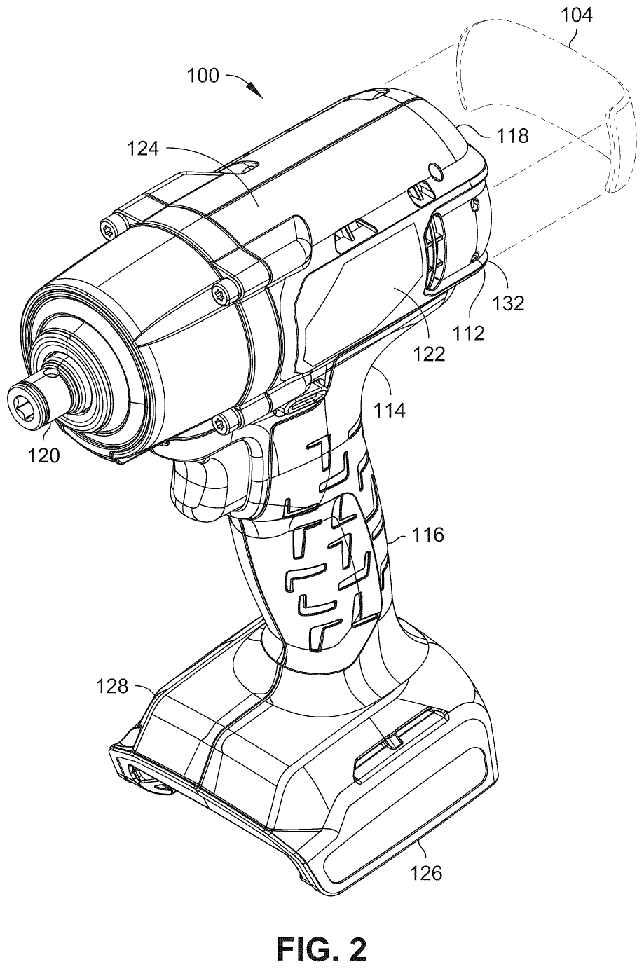

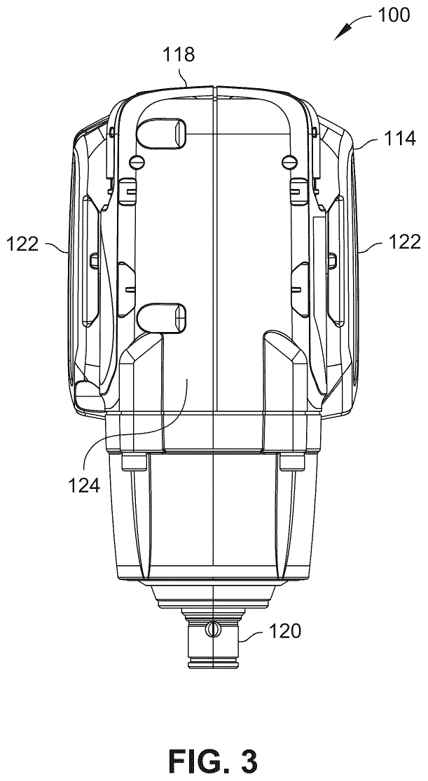

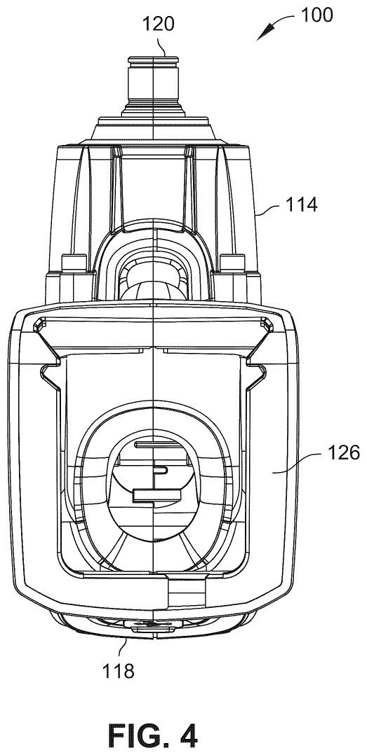

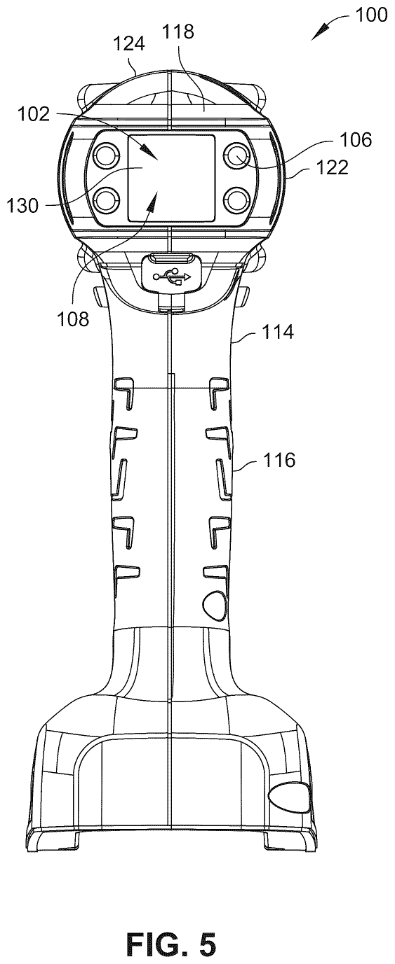

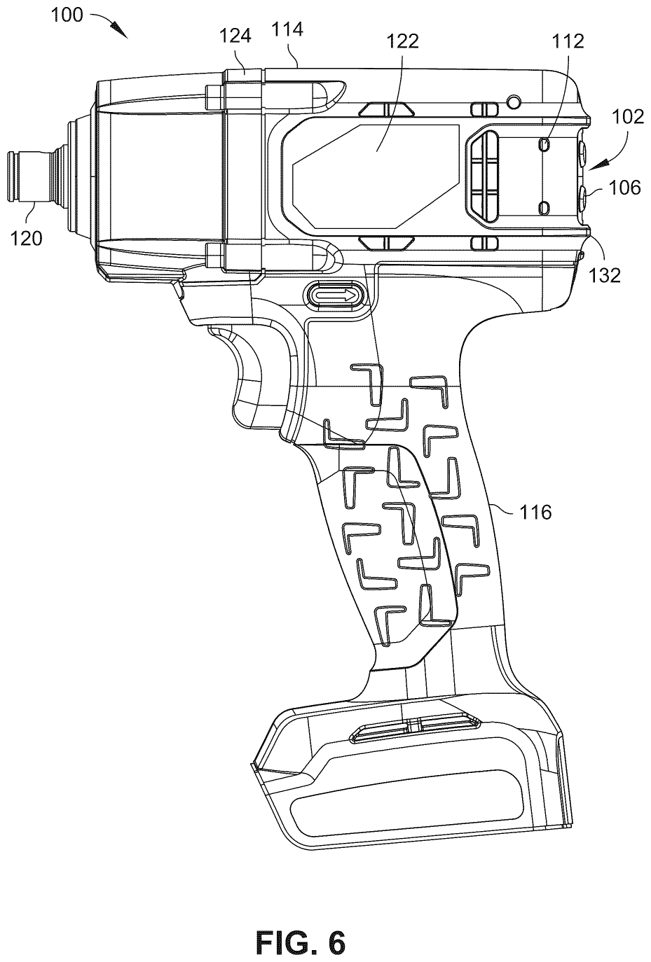

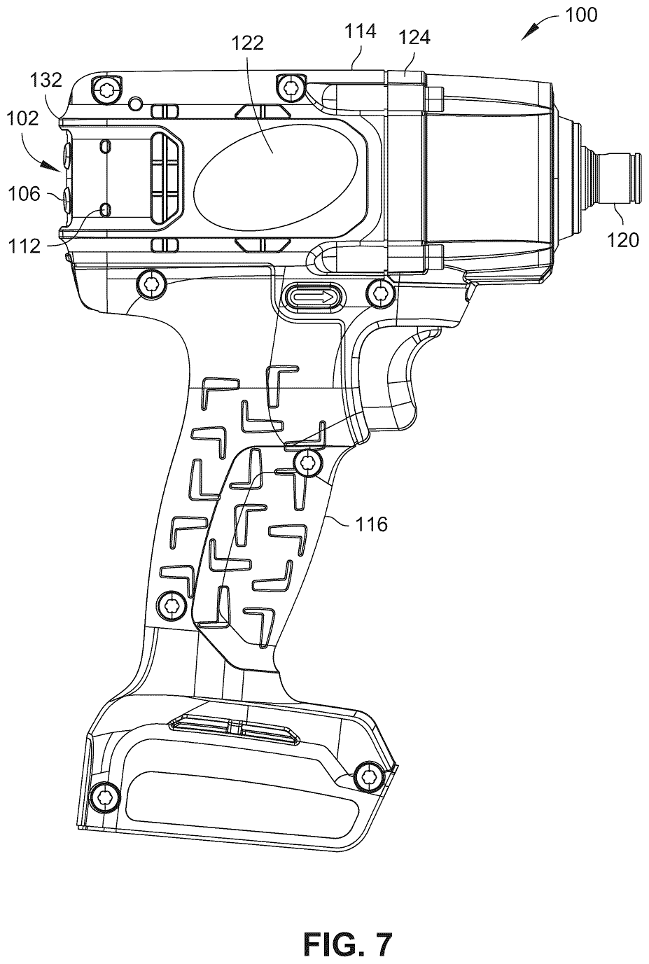

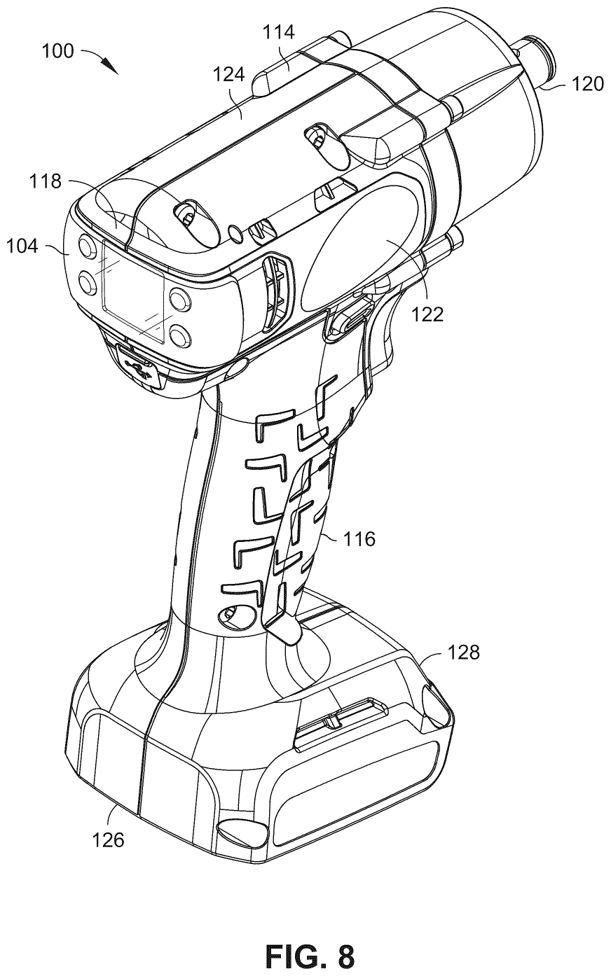

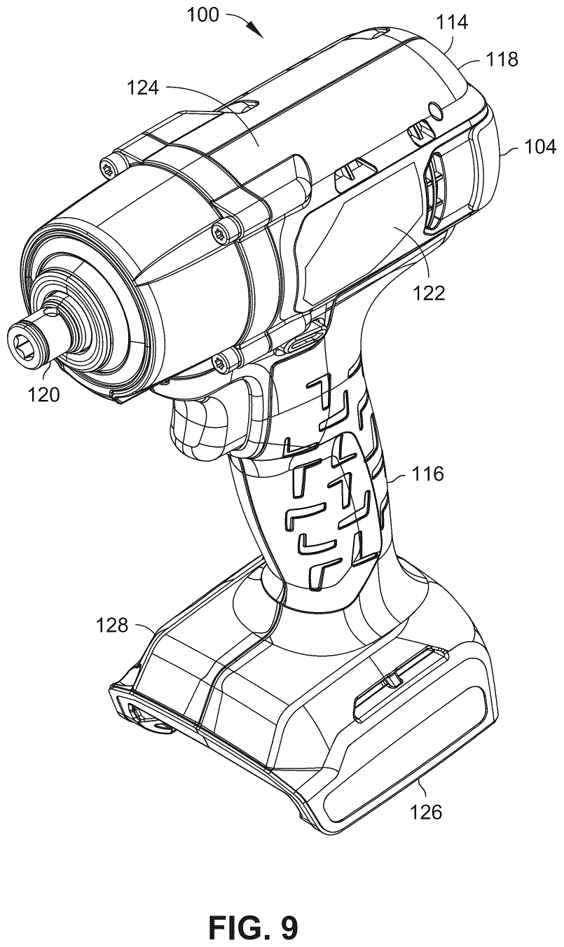

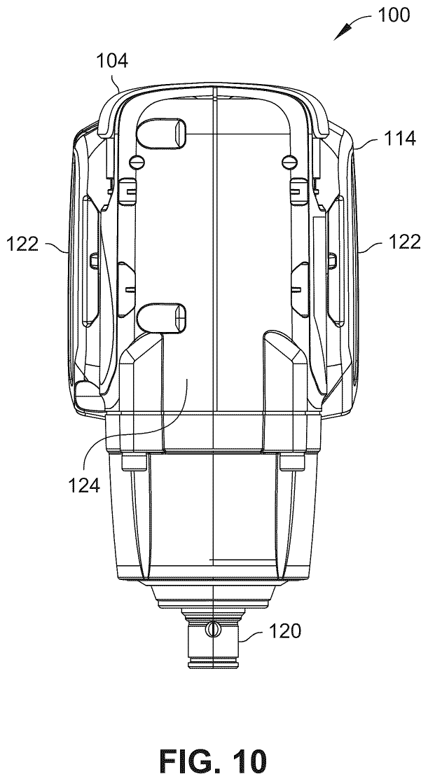

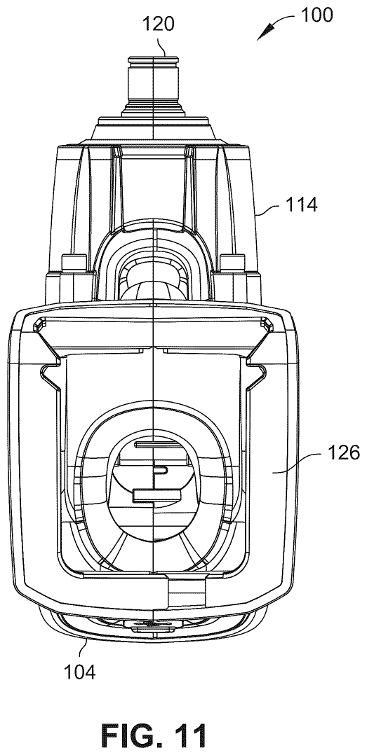

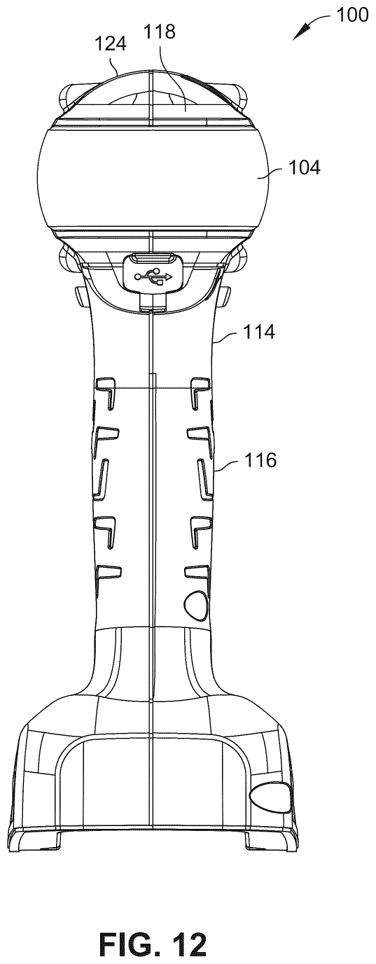

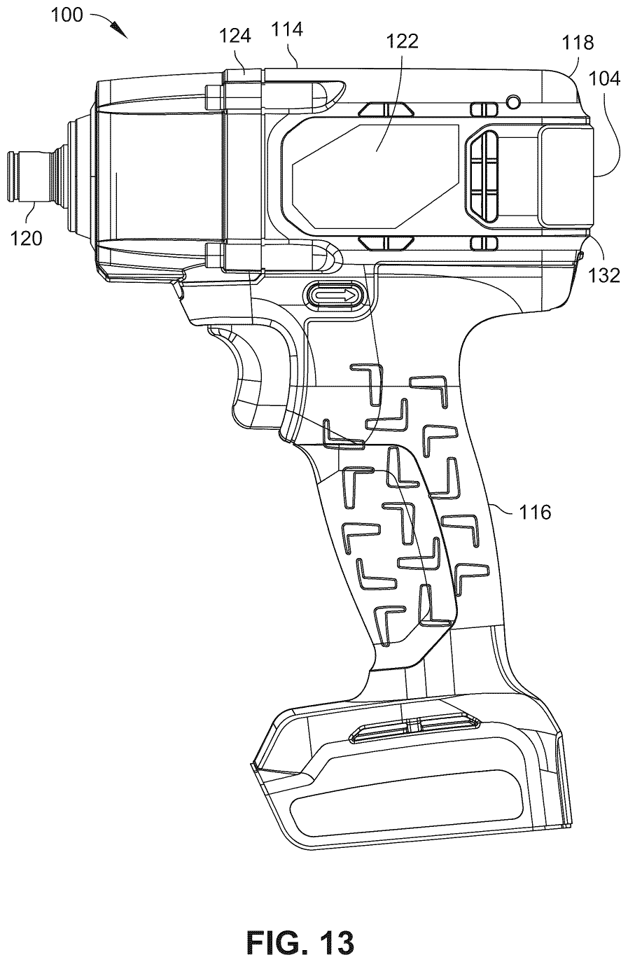

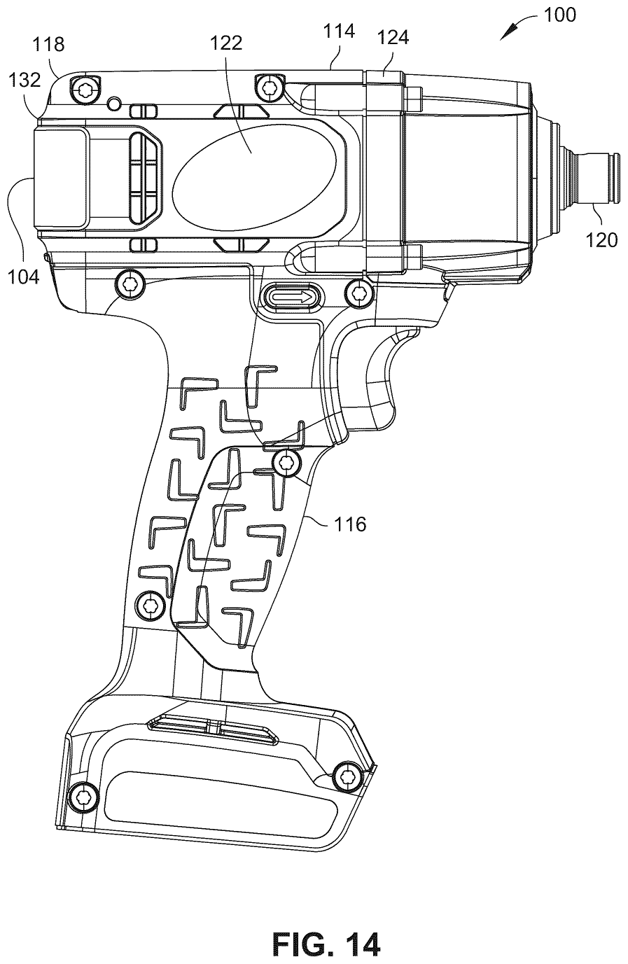

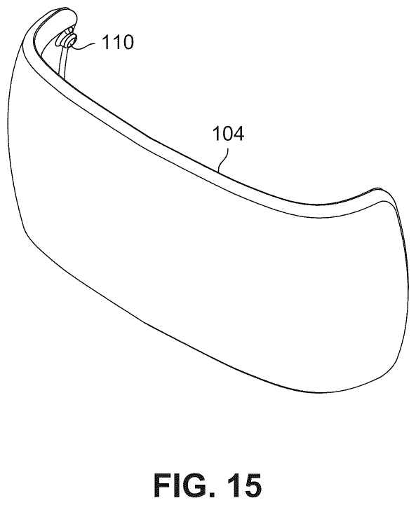

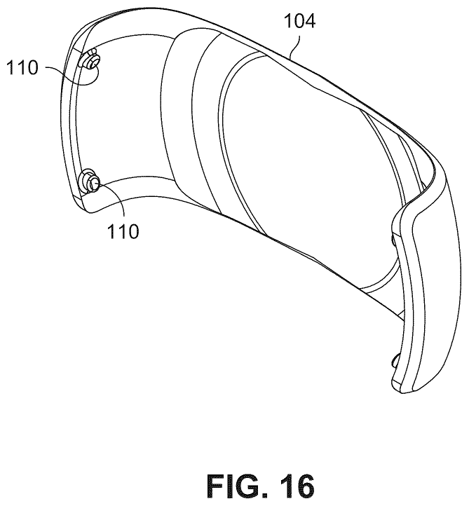

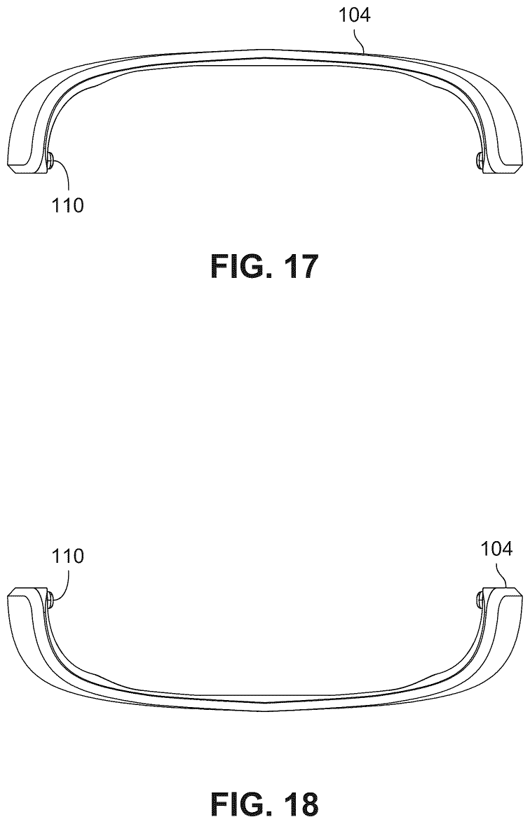

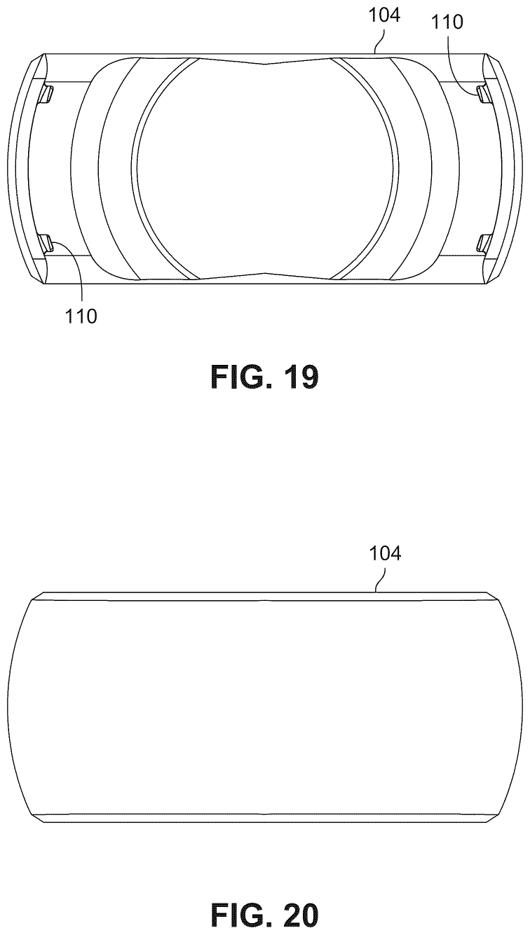

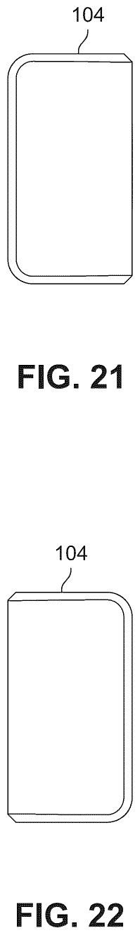

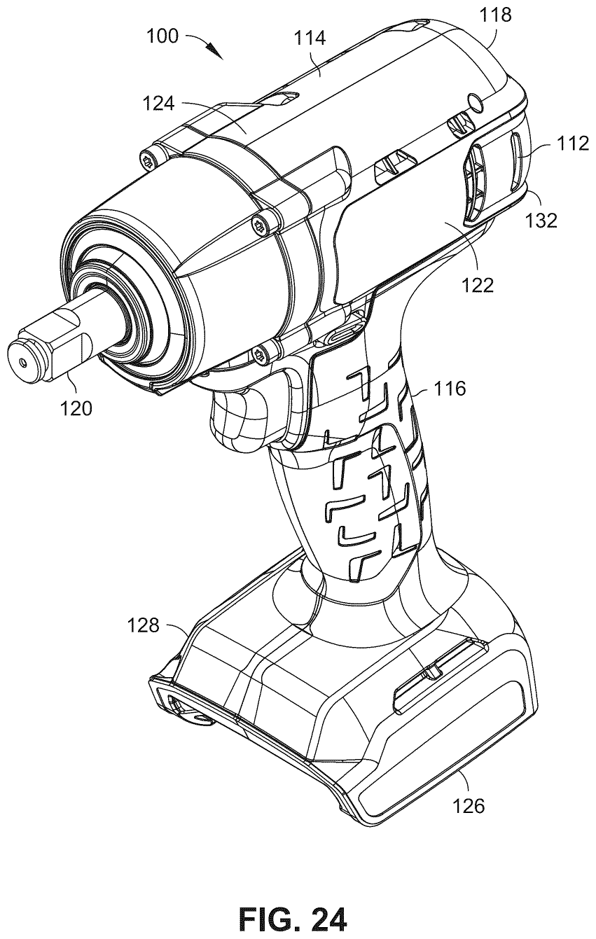

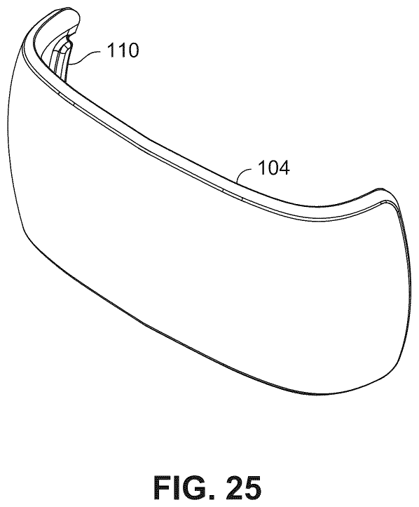

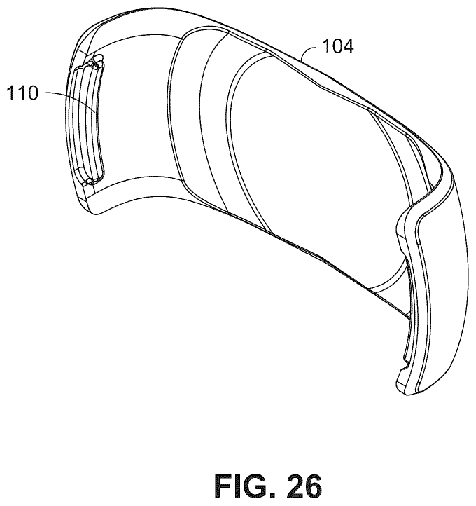

Referring generally to FIGS. 1 through 27, power tools 100 having a user interface 102 and a removable user interface guard 104 are described. As described, the removable user interface guard 104 can protect user input and display/feedback components on the power tool 100 from damage and/or inadvertent operation. The removable user interface guard 104 can be securely attached to the power tool 100, easily removed from the power tool 100, and economically replaced. Power tools are commonly used in environments where space is tight. Consequently, such tools are often bumped or scraped against objects that occupy this space. User interface components such as electronic displays can sustain damage from this contact. Furthermore, user input controls such as keypad buttons can be actuated from this contact, causing unintended changes to the tool's operation and/or setup. The systems, apparatus, and techniques described herein can provide physical protection to these components to prevent these undesirable outcomes.

The removable user interface guard 104 is a strong and durable guard that attaches to the power tool 100 and covers the user interface 102 and user input controls (e.g., buttons 106). The removable user interface guard 104 receives the bumps and scrapes that would otherwise be delivered to the user interface 102 and user input components. In some embodiments, the removable user interface guard 104 can be transparent so as to retain visibility of a display screen 108, such as a liquid crystal display (LCD) screen or another type of screen, which shows important feedback to the operator about the power tool 100, such as cycle status.

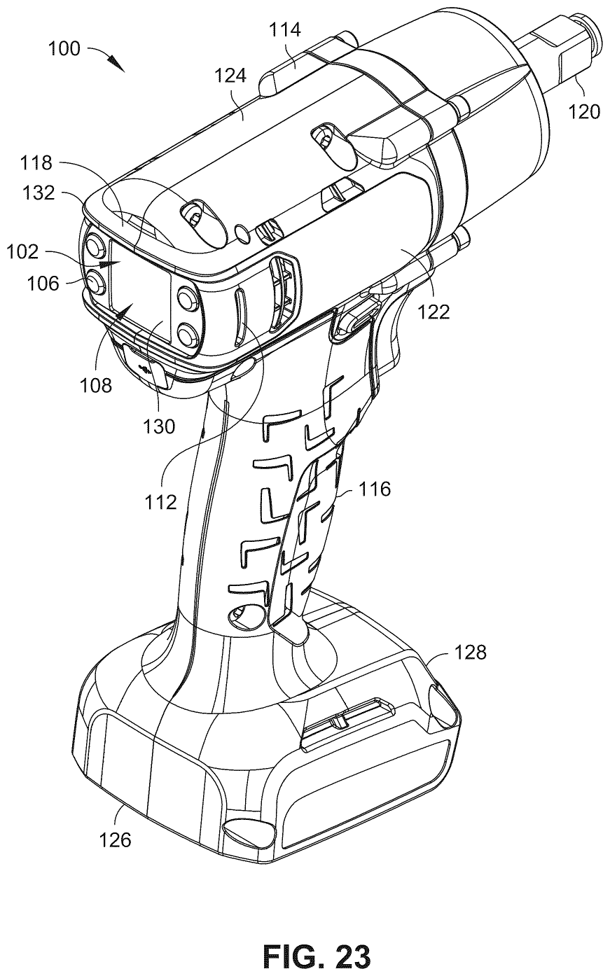

In some embodiments, the removable user interface guard 104 is a transparent cover. The removable user interface guard 104 can include protruding features 110 that can engage with recesses 112 in the housing 114 of the power tool 100 for secure attachment. In some embodiments, each side of the removable user interface guard 104 includes multiple (e.g., two, more than two) protruding features 110 that can engage with multiple corresponding recesses 112 in each side 122 of the housing 114 (e.g., as shown in FIGS. 1 through 22). In some embodiments, each side of the removable user interface guard 104 includes a single protruding feature 110 that engages with a corresponding recess 112 in each side 122 of the housing 114 (e.g., as shown in FIGS. 23 through 26). However, it should be noted that the protruding features 110 and recesses 112 are provided by way of example and are not meant to limit the present disclosure. Other attachment features can also be used to attach the removable user interface guard 104 to the housing 114, such as protruding features on a housing with recesses on a guard, and so forth. Additionally, such features can be mechanically actuated, such as spring biased, and so forth.

The removable user interface guard 104 can cover the display screen 108 to provide additional protection and can cover the buttons 106 of the user interface 102 to protect them and/or prevent them from being actuated when not intended. In instances where operators do not need to actuate these controls, a cover may be preferred to protect the components and/or to deter operators from accessing them. The removable user interface guard 104 can be removed when access to the buttons 106 is needed, and it may be easily replaced if it were to sustain damage. In some embodiments, there is clearance between the removable user interface guard 104 and the components that the removable user interface guard 104 covers, e.g., to allow for deformation that may occur if the power tool 100 were to be dropped or impacted. In some embodiments, the removable user interface guard 104 can be constructed from a strong, transparent or semi-transparent material, such as transparent polycarbonate, which can provide durability to sustain abuse, an ability to deform so that the part may be snapped onto the tool and removed from it, and/or low cost.

In some embodiments, the power tool 100 is a pistol grip type power tool, such as an impact tool having a pistol grip 116. However, a power tool 100 with a pistol grip 116 is provided by way of example and is not meant to limit the present disclosure. In other embodiments, a power tool 100 can be another type of power tool, including, but not necessarily limited to: an in-line tool, a right-angle tool, and so forth.

As described, the user interface 102 can be positioned on a back side 118 of the power tool 100. For instance, the user interface 102 can be positioned opposite a working end 120 of the power tool 100, e.g., facing an operator of the power tool 100 when the operator grips and uses the tool. This placement allows the operator to have good visibility to information displayed on the display screen 108, such as visual feedback. In one example, such feedback can include different colored icons providing an indication of whether an actuator of the power tool 100, such as a trigger, has been actuated for a sufficiently long time to complete an operation on a workpiece (e.g., a red icon indicating an early release of the trigger before completion of an operation). However, a power tool 100 with a user interface 102 positioned on the back side 118 of the power tool 100 is provided by way of example and is not meant to limit the present disclosure. In other embodiments, the user interface 102 can be positioned in one or more other locations, including, but not necessarily limited to: a side 122 of the power tool 100, a top 124 of the power tool 100, a bottom 126 of the power tool 100, at a foot 128 of the power tool 100, and so on.

In some embodiments, having user interface and user input controls located on the back side 118 of the power tool 100 allows the display screen 108 to be readily visible to the operator during use, e.g., for cycle status monitoring. Additionally, the controls are readily accessible for on-tool programming. However, the back side 118 of the power tool can be susceptible to damage and/or unintended actuation. The removable user interface guard 104 offers a secondary layer of protection with a component that is removable and replaceable. This gives more confidence to users and purchasers of the power tool that their investment is well-protected.

For example, positioning the user interface 102 on the back side 118 of the power tool 100 may provide for enhanced convenience and/or accessibility for an operator. However, in some instances the back side 118 of the power tool 100 can be subject to rough handling. For example, an operator may use the back side 118 of a power tool 100 that functions as an impact tool to hammer or pound on a workpiece. In many instances, an impact tool or another expensive power tool 100 may be owned and/or maintained by a company that employs operators who may not be diligent about protecting the back side 118 and the user interface 102 of the power tool 100 (and/or other side(s) where the user interface 102 can be positioned).

In some embodiments, the display screen 108 of the user interface 102 is covered by a transparent or at least semi-transparent display screen cover 130 extending over the display screen 108, where the display screen 108 and the display screen cover 130 are supporting by the housing 114 of the power tool 100. In some embodiments, the display screen cover 130 is made from a tough, impact resistant material, such as a polycarbonate material. However, a display screen cover 130 made from a polycarbonate material is provided by way of example and is not meant to limit the present disclosure. In other embodiments, a display screen cover 130 can be made from one or more other tough and/or impact resistant materials. As described, the display screen cover 130 provides a first layer of protection for the display screen 108.

In embodiments, the user interface 102 also includes one or more selection buttons 106 and/or other actuation features for interacting with the power tool 100. In some embodiments, the power tool 100 includes four (4) selection buttons 106, with sets of two (2) buttons 106 each positioned on opposite sides of the display screen cover 130. As described, a selection button 106 can be used to set one or more desired operational parameters for the power tool 100 via the user interface 102. Operational parameter selections can be displayed via the display screen 108. Such operational parameters can include, but are not necessarily limited to: torque, revolutions per minute (RPM), and so forth.

In some instances, an owner or a manager of the power tool 100 may set one or more operational parameters for the power tool 100 prior to assigning the power tool 100 to an operator. For example, the owner or manager may employ the user interface 102 to set an operational torque for the power tool 100 as required for a particular job prior to assigning the power tool 100 to an operator. As previously discussed, the owner or manager may wish to protect the user interface 102, including the display screen cover 130 and the selection buttons 106, from rough or inadvertent handling, from idle handling, from fidgeting, and so forth. The owner or manager may also wish to prevent contact with the user interface 102, including the display screen cover 130 and the selection buttons 106, which could alter desired settings for the power tool 100. Thus, the power tool 100 may provide a second layer of protection.

In some embodiments, the second layer of protection can include one or more protrusions (e.g., ridges 132), which can be defined by the housing 114 of the power tool 100 and positioned proximate to (e.g., immediately above and/or below) the display screen cover 130. The ridges 132 can protect the display screen cover 130 and/or the selection buttons 106 from an impact by the back side 118 of the power tool 100 with a surface, e.g., by offsetting the user interface 102 from the surface when the back side 118 impacts the surface. It should be noted that the second layer of protection can provide both real protection for the power tool 100 when in use by the operator, as well as perceived protection for an owner or manager of the power tool 100.

As described, the second layer of protection can also be implemented with the removable user interface guard 104, which can attach to the housing 114 of the power tool 100 over (e.g., covering) the user interface 102. In some embodiments, the removable user interface guard 104 can wrap around the power tool 100 to cover or partially cover one or more sides 122 of the power tool. For example, the removable user interface guard 104 can cover the user interface 102 on the back side 118 of the power tool 100 and may also wrap around the two sides 122 of the power tool 100 immediately adjacent to the back side 118. In embodiments of the disclosure, the removable user interface guard 104 can be an inexpensive, easily replaceable part, which can add to the real and/or perceived protection of the power tool 100 offered by the second layer of protection.

In some embodiments, the removable user interface guard 104 is made from a tough, impact resistant material, such as a polycarbonate material. However, a removable user interface guard 104 made from a polycarbonate material is provided by way of example and is not meant to limit the present disclosure. In other embodiments, the removable user interface guard 104 can be made from one or more other tough and/or impact resistant materials, including, but not necessarily limited to: acrylic materials, metal materials, composite materials, and so forth. From the perception of an owner or manager of a power tool 100, the removable user interface guard 104 can be thought of as “safety glasses” for the power tool. In some embodiments, when the power tool 100 is purchased, the power tool 100 can include multiple (e.g., two, more than two) removable user interface guards 104, which may be easily interchanged and replaced in case of damage.

In some embodiments, the removable user interface guard 104 can be transparent or at least semi-transparent. In other embodiments, the removable user interface guard 104 can be opaque. In some embodiments, the removable user interface guard 104 can act as a lens. For example, the removable user interface guard 104 can transmit light from the display screen 108 directly through the material of the removable user interface guard 104, providing no magnification. In other embodiments, the removable user interface guard 104 can act as a magnifying lens, which can increase the apparent size of the display screen 108 when viewed through the removable user interface guard 104. Further, in some embodiments, the removable user interface guard 104 can include one or more coatings and/or surface finishes, such as glare reduction features, reflection reduction features, privacy filter features, color filter features, and so forth.

In some embodiments, the removable user interface guard 104 can be quickly and easily removed from the power tool 100. For instance, the removable user interface guard 104 can slide between the ridges 132 proximate to the user interface 102 (e.g., via dovetail type connections). In other embodiments, the removable user interface guard 104 cannot be easily removed from the power tool 100. In an example, the removable user interface guard 104 can include one or more protruding features 110 on each side of the removable user interface guard 104, which can mate with matching recesses 112 on the sides 122 of the housing 114. In some embodiments, the removable user interface guard 104 can be sufficiently stiff, and/or the fit between the removable user interface guard 104 and the housing 114 can be sufficiently snug, so as to prevent the removable user interface guard 104 from being easily removed from housing 114, e.g., by idle operator activity, such as fidgeting with the removable user interface guard 104 by attaching and detaching it from the housing 114. In this example, a screwdriver or another auxiliary tool may be used to lever the removable user interface guard 104 from the housing 114.

In some embodiments, the removable user interface guard 104 can be connected to the housing of the power tool via a hinge or another attachment mechanism, where the removable user interface guard 104 can be hinged out and away from the power tool 100, but also removed from the power tool 100, e.g., by pulling the removable user interface guard 104 from the housing 114 at the hinge connection, which can be, for example, a friction fit. In some embodiments, the removable user interface guard 104 can include one or more resilient attachment features, e.g., elastomeric overmolding on the polycarbonate lens, which can be compliant for absorbing impacts, such as a drop onto the back side 118 of the power tool 100, and/or which may also provide a seal for preventing material (e.g., moisture, debris, etc.) from infiltrating past the removable user interface guard 104 to the user interface 102.

In some embodiments, the removable user interface guard 104 can be semi-permanently attached to the power tool 100 (e.g., secured with an auxiliary tool and not removable without the auxiliary tool, such as a screwdriver). For instance, the removable user interface guard 104 can be connected to the housing 114 by one or more fasteners (e.g., screws), which can be inserted through the removable user interface guard 104 and connected to the sides 122 of the housing 114 (e.g., via threaded connection(s) to the housing 114).

As described, portions of the removable user interface guard 104 can be offset from the display screen cover 130 and/or the selection buttons 106. The offset can be used to prevent the removable user interface guard 104 from contacting the user interface 102 if it deforms (e.g., bows inwardly) in an impact to the back side 118 of the power tool 100. In some embodiments, the removable user interface guard 104 can be offset from the selection buttons 106 a sufficient distance for an operator to access a selection button 106 by reaching behind the removable user interface guard 104 to contact a selection button 106. In some embodiments, the removable user interface guard 104 can include one or more compliant features, such as flexible, co-molded buttons that can be used to press the selection buttons 106 by pressing on the removable user interface guard 104 at the buttons 106.

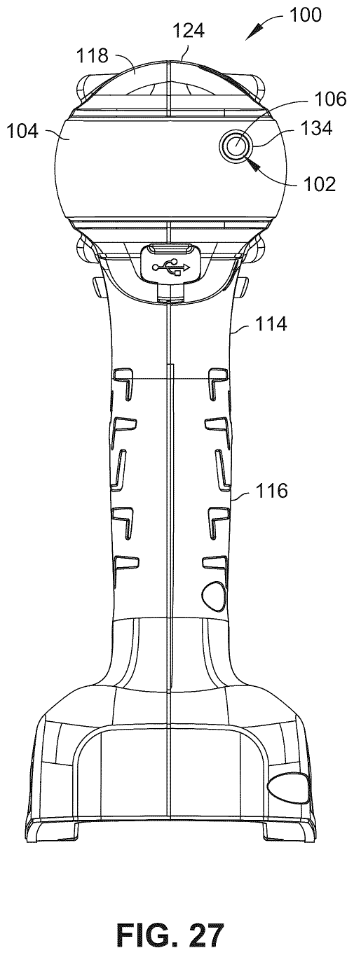

With reference to FIG. 27, in some embodiments the removable user interface guard 104 can include an access port 134, such as an aperture or another type of access point, for accessing a button 106 (or buttons) through the removable user interface guard 104. The access port 134 can be used to provide access to a button 106 (or buttons) that may be frequently accessed during operation of the power tool 100 and would otherwise require frequent attachment and detachment of the removable user interface guard 104. For example, an access port 134 can be used to facilitate access to a button used for changing between operational presets store in the power tool 100 (e.g., to change operational modes of the tool).

As described, the protrusions/ridges 132 defined by the housing 114 of the power tool 100 and positioned proximate to the display screen cover 130 can be shaped to create an aesthetically pleasing form factor for the power tool 100, e.g., in combination with the removable user interface guard 104. For example, the removable user interface guard 104 can rest between the ridges 132, completing an arcuate profile at the back side 118 of the power tool 100.

Although the subject matter has been described in language specific to structural features and/or process operations, it is to be understood that the subject matter defined in the appended claims is not necessarily limited to the specific features or acts described above. Rather, the specific features and acts described above are disclosed as example forms of implementing the claims.

What is claimed is:

1. A power tool comprising:
a housing having a working end and a side separate from the working end;
a user interface supported by the housing and positioned on the side of the housing, the user interface including a display screen and a plurality of buttons;
a protrusion defined by the housing proximate to the user interface and extending away from the housing for protecting the user interface from an impact on the side of the housing; and
a removable user interface guard including
a body configured to be secured to the side of the housing over the user interface and formed of an impact resistant material for protecting the user interface of the power tool from an impact at the side of the power tool, and
a retention feature on the body configured to mate with a corresponding feature on the housing of the power tool to removably secure the body to the side of the housing over the user interface.

2. The power tool as recited in claim 1, wherein the side separate from the working end is a back side opposite the working end.

3. The power tool as recited in claim 1, further comprising a second protrusion proximate to the user interface opposite the first protrusion for protecting the user interface from an impact on the side of the housing.

4. The power tool as recited in claim 1, wherein the retention feature on the body of the removable user interface guard comprises at least one protruding feature, and the corresponding feature on the housing of the power tool comprises at least one recess.

5. The power tool as recited in claim 1, wherein the body of the removable user interface guard comprises at least one access port defined through the body to provide access to at least one of the plurality of buttons.

6. The power tool as recited in claim 1, wherein the removable user interface guard and the protrusion defined by the housing complete an arcuate profile at the side of the housing.

7. A power tool comprising:
a housing having a working end and a side separate from the working end;
a user interface supported by the housing and positioned on the side of the housing; and
a protrusion defined by the housing proximate to the user interface and extending away from the housing for protecting the user interface from an impact on the side of the housing.

8. The power tool as recited in claim 7, wherein the user interface comprises a display screen and a plurality of buttons.

9. The power tool as recited in claim 7, wherein the side separate from the working end is a back side opposite the working end.

10. The power tool as recited in claim 7, further comprising a second protrusion proximate to the user interface opposite the first protrusion for protecting the user interface from an impact on the side of the housing.

11. The power tool as recited in claim 7, further comprising a removable user interface guard configured to be secured to the side of the housing over the user interface.

12. The power tool as recited in claim 11, wherein the removable user interface guard comprises:
a body formed of an impact resistant material for protecting the user interface of the power tool from an impact at the side of the power tool; and
a retention feature on the body configured to mate with a corresponding feature on the housing of the power tool to removably secure the body to the side of the housing over the user interface.

13. The power tool as recited in claim 12, wherein the retention feature on the body of the removable user interface guard comprises at least one protruding feature, and the corresponding feature on the housing of the power tool comprises at least one recess.

14. The power tool as recited in claim 12, wherein the body of the removable user interface guard comprises at least one access port defined through the body to provide access to at least one of the plurality of buttons.

15. The power tool as recited in claim 11, wherein the removable user interface guard and the protrusion defined by the housing complete an arcuate profile at the side of the housing.

16. A removable user interface guard for a power tool, the power tool having a housing with a side separate from a working end, a user interface supported by the housing and positioned on the side of the housing, the removable user interface guard comprising:
a body configured to be secured to the side of the housing over the user interface and formed of an impact resistant material for protecting the user interface of the power tool from an impact at the side of the power tool; and
a retention feature on the body configured to mate with a corresponding feature on the housing of the power tool to removably secure the body to the side of the housing over the user interface.

17. The removable user interface guard as recited in claim 16, wherein the retention feature on the body of the removable user interface guard comprises at least one protruding feature, and the corresponding feature on the housing of the power tool comprises at least one recess.

18. The removable user interface guard as recited in claim 16, wherein the body of the removable user interface guard comprises at least one access port defined through the body to provide access to the user interface.

19. The removable user interface guard as recited in claim 16, wherein the removable user interface guard has an arcuate profile.

20. The removable user interface guard as recited in claim 16, wherein the removable user interface guard is configured to wrap at least partially around additional sides of the power tool proximate to the user interface.
